(19) United States
(12) Patent Application Publication
(10) Pub. No.: US 2026/0029058 A1
(43) Pub. Date: Jan. 29, 2026

(54) SPOOL VALVE

(71) Applicant: Wolf Tooth Components, LLC, Burnsville, MN (US)

(72) Inventor: Michael W. Pfeiffer, Burnsville, MN (US)

(73) Assignee: Wolf Tooth Components, LLC, Burnsville, MN (US)

(21) Appl. No.: 19/279,642

(22) Filed: Jul. 24, 2025

Related U.S. Application Data
(60) Provisional application No. 63/674,900, filed on Jul. 24, 2024.

(51) Int. Cl. F16K 11/07; B62J 1/08

(52) U.S. Cl. CPC F16K 11/0716; B62J 1/08; B62J 2001/085

(57) ABSTRACT

A spool valve for a height adjustment seat post for a saddle of a bicycle includes a spool valve housing, a spool valve body positioned within the spool valve housing, and a spool valve sleeve supported by the spool valve housing, with the spool valve body including a radial fluid port and the spool valve sleeve including a fluid port, and the spool valve sleeve fit over the spool valve body and slidable relative to the spool valve housing and the spool valve body to communicate the fluid port of the spool valve sleeve with the radial fluid port of the spool valve body.

### CROSS-REFERENCE TO RELATED APPLICATIONS

This application claims priority under 35 U.S.C. 119 (e) to U.S. Provisional Patent Application Ser. No. 63/674,900 filed on Jul. 24, 2024, and incorporated herein by reference.

### BACKGROUND

The present disclosure relates generally to a spool valve and, more specifically, relates to a spool valve for a height adjustment seat post for a saddle of a bicycle.

### BRIEF DESCRIPTION OF THE DRAWINGS

FIGS. 1, 2, 3, 4, 5, 6 illustrate an example of a height adjustment seat post in accordance with the present disclosure.

FIGS. 7, 8, 9, 10 illustrate an example of a spool valve for a height adjustment seat post in accordance with the present disclosure.

FIGS. 11A, 11B illustrate an example of a spool valve in accordance with the present disclosure.

FIG. 12 illustrates an example implementation of a spool valve for a height adjustment seat post for a saddle of a bicycle in accordance with the present disclosure.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

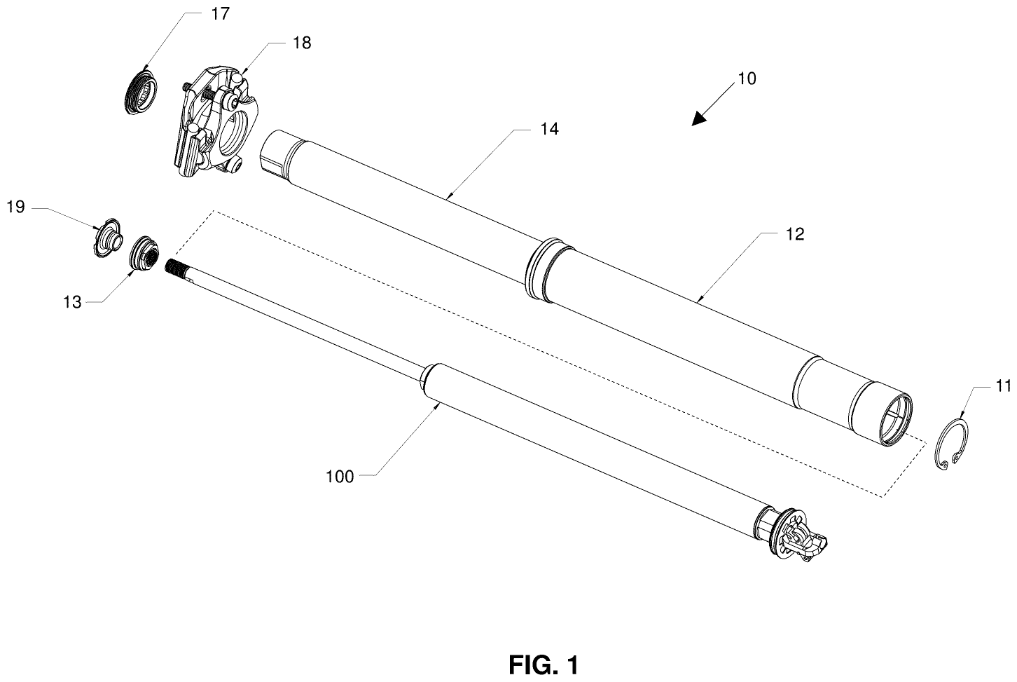

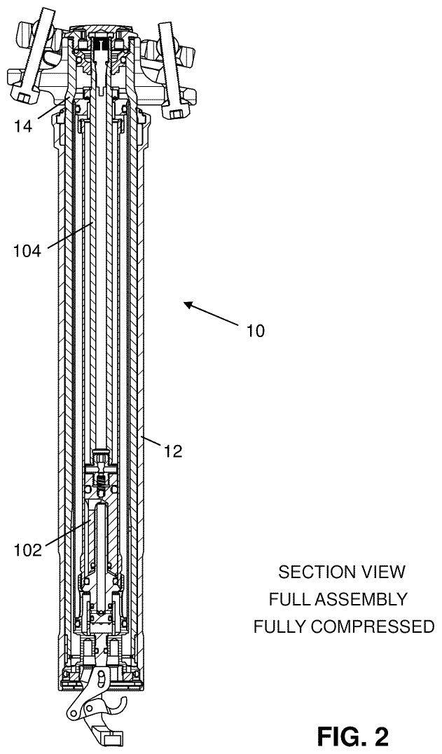

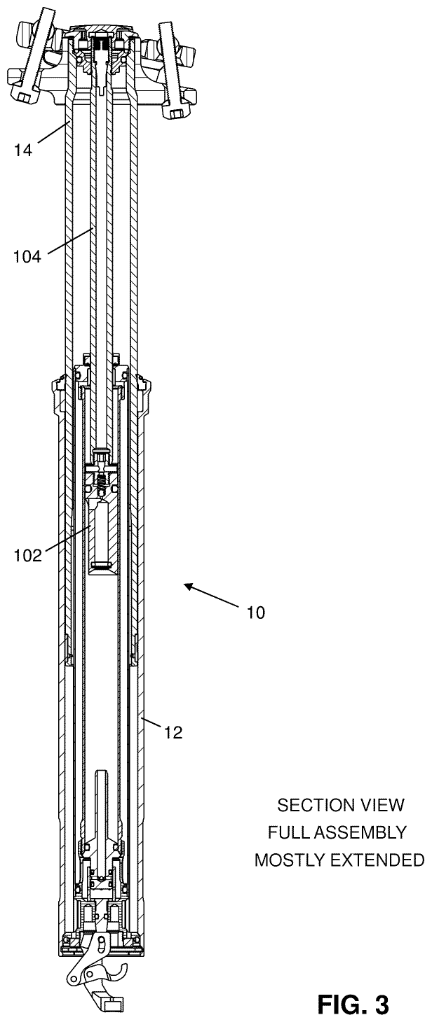

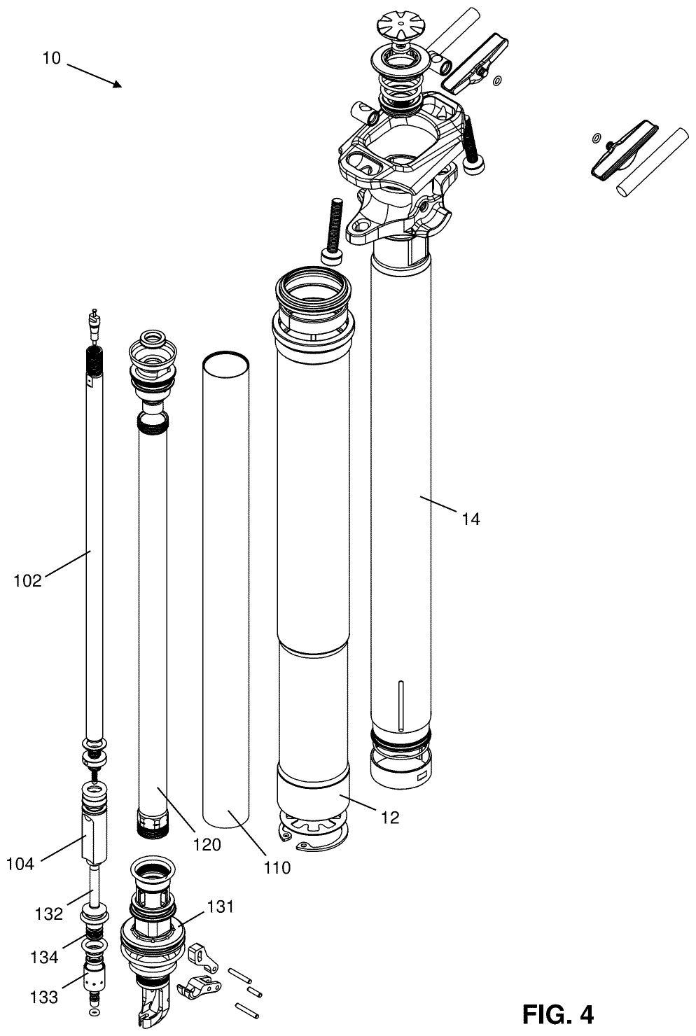

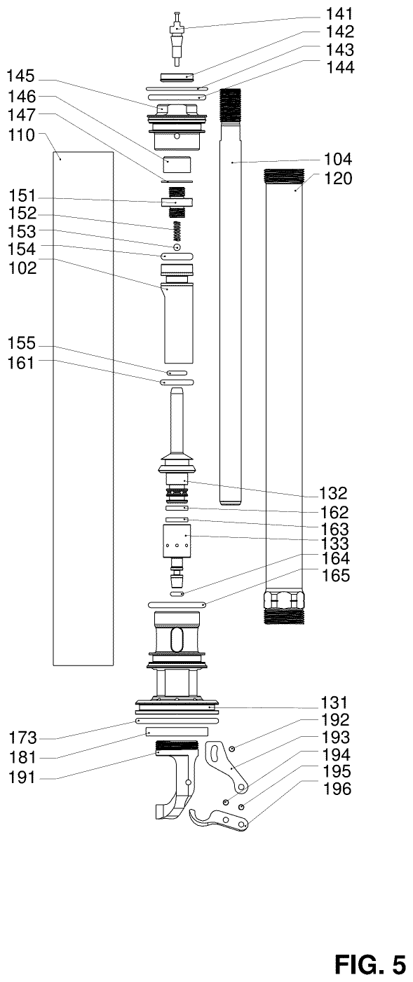

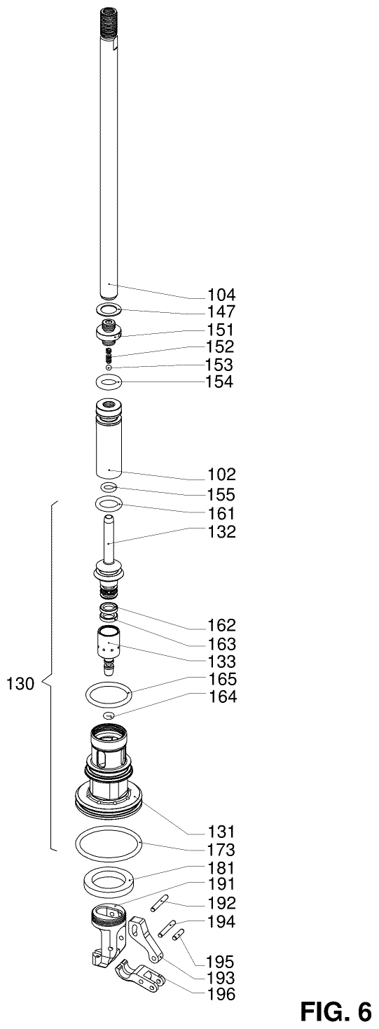

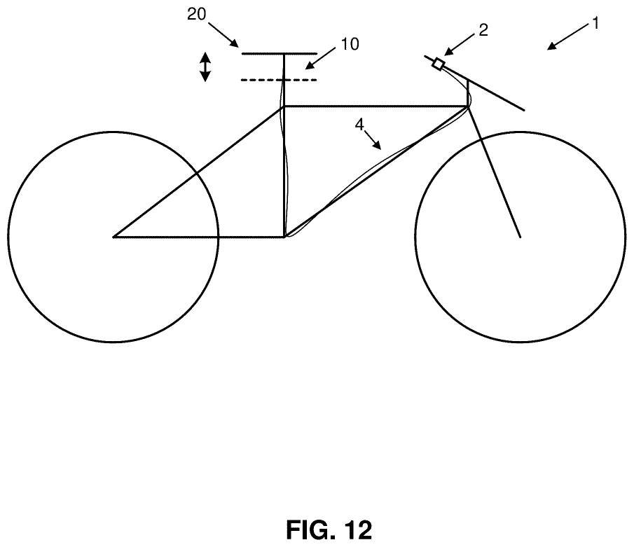

FIGS. 1, 2, 3, 4, 5, 6 illustrate an example of a height adjustment seat post 10 in accordance with the present disclosure. In examples, the height adjustment seat post 10 includes a lower housing 12, a stanchion 14 telescopically supported within the lower housing 12, and a cartridge 100 supported within the lower housing 12 and the stanchion 14 to telescopically adjust (e.g., raise and lower) the stanchion 14 relative to the lower housing 12. In examples, the cartridge 100 includes a piston 102 and a piston rod 104 driven by the piston 102 to telescopically adjust the stanchion 14 relative to the lower housing 12. In examples, a saddle clamp assembly 18 is secured to the stanchion 14, for example, by a lock ring 17, to support a saddle for a bicycle (such as, for example, the saddle 20 for the bicycle 1 of FIG. 12). In examples, an end of the cartridge 100 is retained within the lower housing 12 by a snap ring 11, and an end of the piston rod 104 is secured to an end of the stanchion 14 by an upper cap 13. In examples, an air cap 19 covers the end of the height adjustment seat post 10.

In examples, the cartridge 100n includes a reservoir 110, a cylinder 120, and a spool valve 130. In examples, the spool valve 130 includes a spool valve housing 131, a spool valve needle 132, and a spool valve sleeve 133. In examples, the spool valve 130 includes associated seals, rings, and O-rings, as illustrated.

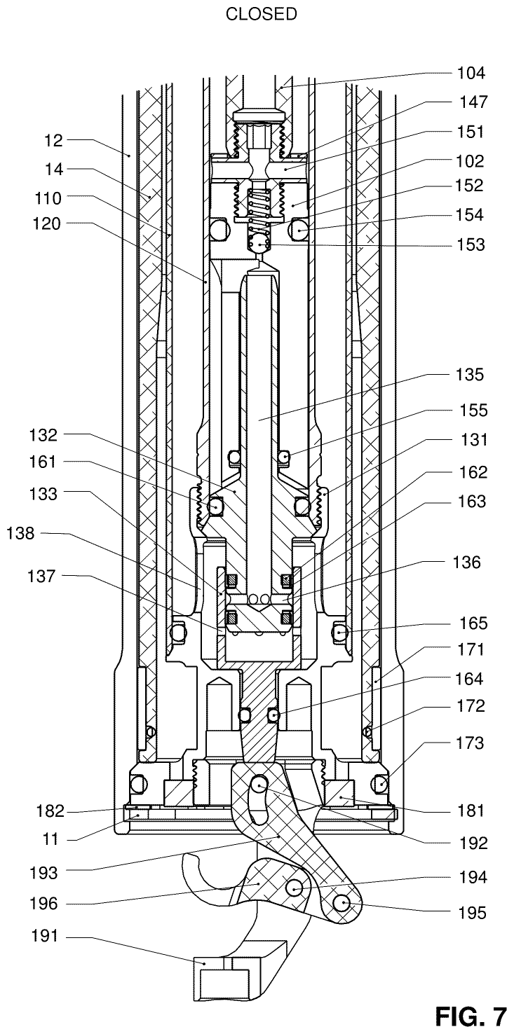

FIGS. 7, 8, 9, 10 illustrate an example of a spool valve for a height adjustment seat post in accordance with the present disclosure, such as, for example, the spool valve 130 for the height adjustment seat post 10.

In examples, the reservoir 110 is formed of a cylindrical member, and the cylinder 120 is positioned within the reservoir 110. In examples, the cylinder 120 is secured to the spool valve housing 131 and the spool valve housing 131 is positioned within an end of the reservoir 110. In examples, the cylinder 120 is of a diameter less than the reservoir 110 and is positioned concentrically within the reservoir 110 such that a volume A is formed between the reservoir 110 and the cylinder 120. In examples, a volume B is formed within the cylinder 120.

In examples, the spool valve needle 132 is secured within the spool valve housing 131 and communicates with volume B formed within the cylinder 120. In examples, the spool valve needle 132 includes a spool valve body 134 positioned within the spool valve housing 131, and the spool valve sleeve 133 is supported by the spool valve housing 131. In examples, the spool valve sleeve 133 fits over the spool valve body 134 of the spool valve needle 132 and is slidable relative to the spool valve housing 131 and the spool valve body 134.

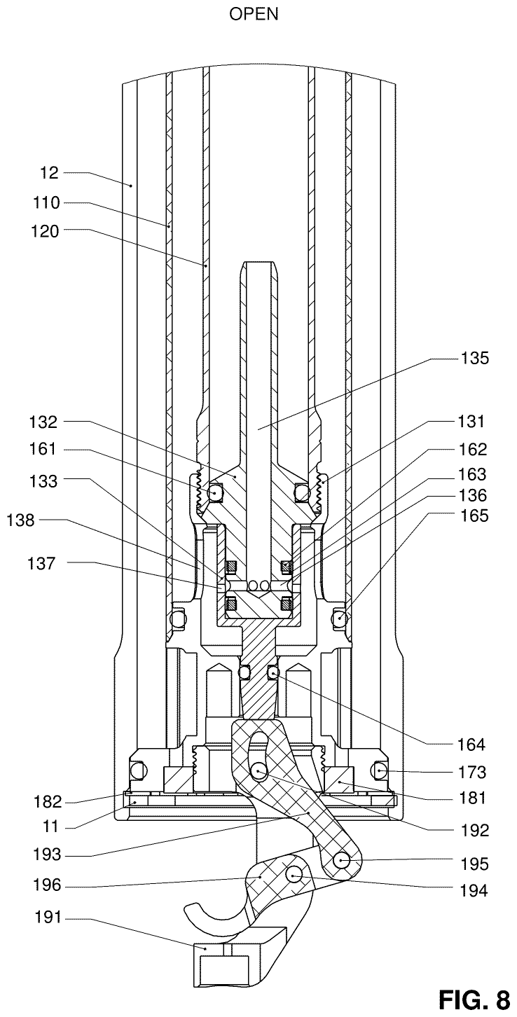

In examples, the spool valve sleeve 133 is slidable relative to the spool valve housing 131 and the spool valve body 134 of the spool valve needle 132 to establish an open position (e.g., FIG. 8) and a closed position (e.g., FIG. 7) of the spool valve 130. In examples, the spool valve sleeve 133 is biased to the closed position and is actuated to the open position. In examples, the spool valve sleeve 133 is biased to the closed position by internal air pressure. In examples, the spool valve sleeve 133 is actuated by a linkage to slide (e.g., push) the spool valve sleeve 133 relative to the spool valve body 134 to establish the open position. The spool valve 130, therefore, is an inverse spool valve (i.e., the spool valve sleeve 133 slides relative to the spool valve body 134).

In examples, the spool valve needle 132 includes an axial fluid port 135 and one or more than one radial fluid port 136 communicated with the axial fluid port 135. In examples, the axial fluid port 135 extends to an end of the spool valve needle 132. In examples, the radial fluid port 136 is formed in the spool valve body 134 and extends radially from the axial fluid port 135 to an outer surface of the spool valve body 134. In examples, the spool valve sleeve 133 includes one or more than one fluid port 137 and the spool valve housing 131 includes one or more than one fluid port 138.

In examples, in the closed position (e.g., FIG. 7), the spool valve sleeve 133 covers or blocks the radial fluid port 136 of the spool valve needle 132 such that fluid (e.g., oil) within volume A is precluded from communication with fluid (e.g., oil) within volume B.

In examples, in the open position (e.g., FIG. 8), the fluid port 137 of the spool valve sleeve 133 communicates with the radial fluid port 136 of the spool valve needle 132 such that fluid (e.g., oil) within volume A is communicated with fluid (e.g., oil) within volume B through the fluid port 138 of the spool valve housing 131, through the fluid port 137 of the spool valve sleeve 133, through the radial fluid port 136 of the spool valve needle 132, and through the axial fluid port 135 of the spool valve needle 132. In examples, fluid within volume B acts on a piston (e.g., piston 102) of the cartridge 100 to actuate a piston rod (e.g., piston rod 104) of the cartridge 100 to extend the stanchion 14 relative to the lower housing 12.

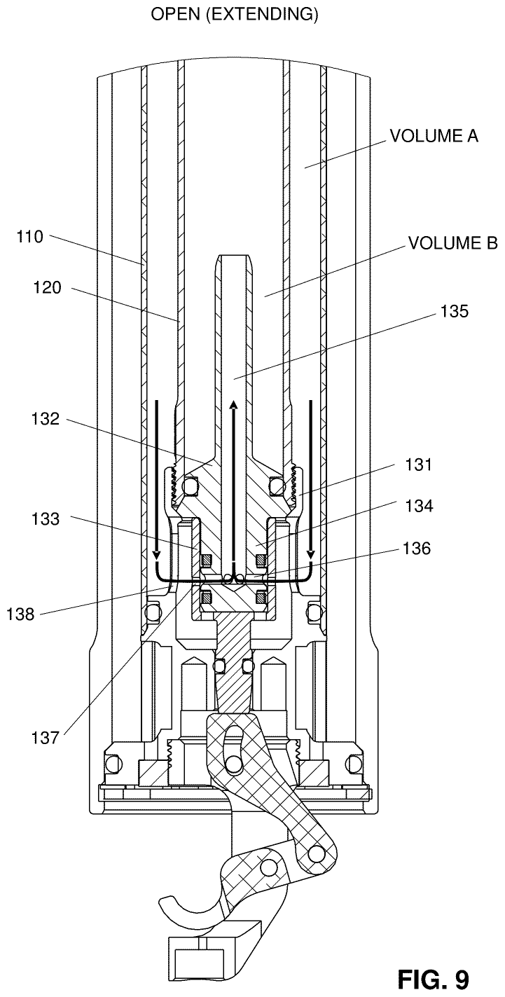

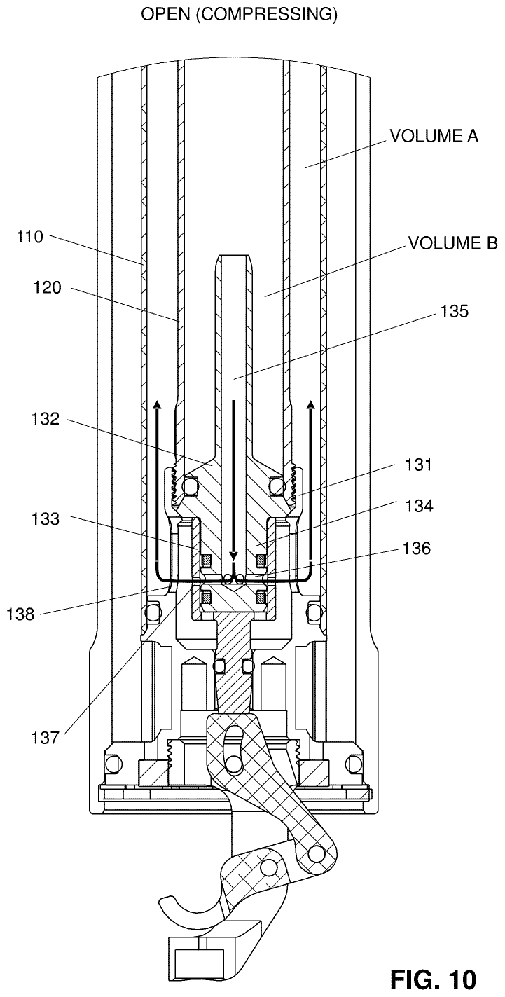

In examples, based on a state of the height adjustment seat post 10 (e.g., extending or compressing), fluid may flow from volume A to (or toward) volume B, as illustrated in FIG. 9, or may flow from volume B to (or toward) volume A, as illustrated in FIG. 10. More specifically, as illustrated in the example of FIG. 9, with the spool valve 130 in the open position and the height adjustment seat post 10 in an extending state, fluid from volume A flows through the fluid port 138 of the spool valve housing 131, through the fluid port 137 of the spool valve sleeve 133, through the radial fluid port 136 of the spool valve needle 132, and through the axial fluid port 135 of the spool valve needle 132 to (or toward) volume B. In addition, as illustrated in the example of FIG. 10, with the spool valve 130 in the open position and the height adjustment seat post 10 in a compressing state, fluid from volume B flows through the axial fluid port 135 of the spool valve needle 132, through the radial fluid port 136 of the spool valve needle 132, through the fluid port 137 of the spool valve sleeve 133, and through the fluid port 138 of the spool valve housing 131 to (or toward) volume A.

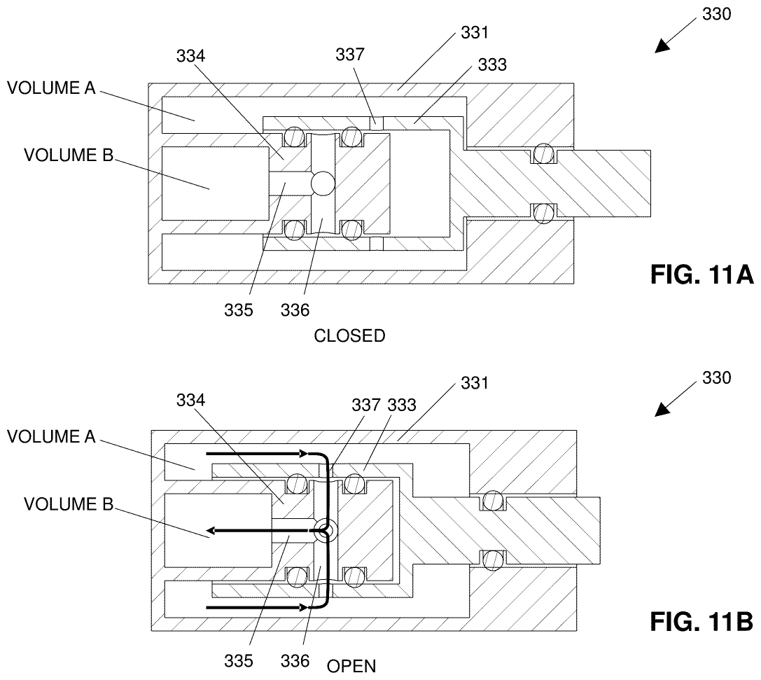

FIGS. 11A, 11B illustrate an example of a spool valve in accordance with the present disclosure.

In examples, the spool valve 330, as an example of the spool valve 130, includes a spool valve housing 331, a spool valve body 334 positioned within the spool valve housing 331, and a spool valve sleeve 333 supported by the spool valve housing 331. In examples, the spool valve sleeve 333 fits over the spool valve body 334 and is slidable relative to the spool valve housing 331 and the spool valve body 334.

In examples, the spool valve sleeve 333 is slidable relative to the spool valve housing 331 and the spool valve body 334 to establish an open position (FIG. 11B) and a closed position (FIG. 11A) of the spool valve 330. In examples, the spool valve sleeve 333 is biased to the closed position and is actuated (e.g., pushed) to establish the open position.

In examples, the spool valve body 334 includes an axial fluid port 335 and one or more than one radial fluid port 336 communicated with the axial fluid port 335. In examples, the axial fluid port 335 extends to an end of the spool valve body 334. In examples, the radial fluid port 336 extends radially from the axial fluid port 335 to an outer surface of the spool valve body 334. In examples, the spool valve sleeve 333 includes one or more than one fluid port 337.

In examples, in the closed position, the spool valve sleeve 333 covers or blocks the radial fluid port 336 of the spool valve body 334 such that fluid within volume A is prevented from communicating with fluid within volume B.

In examples, in the open position, the fluid port 337 of the spool valve sleeve 333 communicates with the radial fluid port 336 of the spool valve body 334 such that fluid within volume A is communicated with fluid within volume B through the fluid port 337 of the spool valve sleeve 333, through the radial fluid port 336 of the spool valve body 334, and through the axial fluid port 335 of the spool valve body 334.

In examples, based on a state of the spool valve 330, fluid may flow from volume A to (or toward) volume B, as illustrated in FIG. 11B, or may flow from volume B to (or toward) volume A.

FIG. 12 illustrates an example implementation of a spool valve for a height adjustment seat post for a saddle of a bicycle 1 in accordance with the present disclosure, such as, for example, the height adjustment seat post 10 for the saddle 20. In examples, a control device 2 may be mounted on a bicycle (e.g., a handlebar of a bicycle), such that operation or actuation of the control device 2 may be used to apply pull to an actuation or control cable 4 coupled with a height adjustment seat post for a saddle of a bicycle, such as, for example, the height adjustment seat post 10 for the saddle 20. In examples, the height adjustment seat post 10 includes a spool valve in accordance with the present disclosure, such as, for example, the spool valve 130.

A spool valve as disclosed herein, such as, for example, the spool valve 130, provides a non-pressure balanced, inverse spool valve with push-to-open actuation for a height adjustment seat post for a saddle of a bicycle, such as, for example, the height adjustment seat post 10.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

Reference numerals in the drawings correspond to the following components or elements:
1 Bicycle
2 Control Device
4 Control Cable
10 Height Adjustment Seat Post
11 Snap Ring
12 Lower Housing
13 Upper Cap
14 Stanchion
17 Lock Ring
18 Saddle Clamp Assembly
19 Air Cap
20 Saddle
100 Cartridge
102 Piston
104 Piston Rod
110 Reservoir
120 Cylinder
130 Spool Valve
131 Spool Valve Housing
132 Spool Valve Needle
133 Spool Valve Sleeve
134 Spool Valve Body
135 Axial Fluid Port
136 Radial Fluid Port
137 Fluid Port
138 Fluid Port
141 Valve Core
142 U-Cup Seal
143 Cylinder Cap Bumper O-Ring
144 Upper Cylinder O-Ring
145 Cylinder Cap
146 Bushing, Piston Rod
147 Top Out Bumper
151 Piston Rod Coupler
152 Piston Relief Valve Spring
153 Piston Relief Valve Ball
154 Piston External Seal O-Ring
155 Piston Internal Seal O-Ring
161 Lower Cylinder O-Ring
162 Rubber Backing Ring
163 PFTE Seal
164 Spool Valve O-Ring
165 Lower Reservoir O-Ring
171 Lower Bushing
172 Lower Stanchion O-Ring
173 Lower Housing O-Ring
181 Reticulated Foam Filter
182 Plastic Filter Retainer
191 Linkage, Housing
192 Dowel Pin 2.0 MM×14.0 MM
193 Linkage, Slider
194 Dowel Pin 2.0 MM×14.0 MM
195 Dowel Pin 2.0 MM×8.0 MM
196 Linkage, Rocker
330 Spool Valve
331 Spool Valve Housing
333 Spool Valve Sleeve
334 Spool Valve Body
335 Axial Fluid Port
336 Radial Fluid Port
337 Fluid Port

1. A spool valve for a height adjustment seat post for a saddle of a bicycle, the spool valve comprising:
a spool valve housing;
a spool valve body positioned within the spool valve housing; and
a spool valve sleeve supported by the spool valve housing,
the spool valve body including a radial fluid port and the spool valve sleeve including a fluid port,
the spool valve sleeve fit over the spool valve body and slidable relative to the spool valve housing and the spool valve body to communicate the fluid port of the spool valve sleeve with the radial fluid port of the spool valve body.

2. The spool valve of claim 1, wherein:
the spool valve body including an axial fluid port communicated with the radial fluid port.

3. The spool valve of claim 2, wherein:
the axial fluid port extending to an end of the spool valve body.

4. The spool valve of claim 2, wherein:
the radial fluid port extending radially from the axial fluid port to an outer surface of the spool valve body.

5. The spool valve of claim 1, wherein:
the spool valve sleeve slidable relative to the spool valve housing and the spool valve body to establish an open position and a closed position of the spool valve.

6. The spool valve of claim 5, wherein:
the spool valve sleeve biased to the closed position and actuated to establish the open position.

7. The spool valve of claim 5, wherein:
in the closed position, the spool valve sleeve to cover the radial fluid port of the spool valve body.

8. The spool valve of claim 5, wherein:
in the open position, the fluid port of the spool valve sleeve to communicate with the radial fluid port of the spool valve body.

9. The spool valve of claim 1, wherein:
the radial fluid port of the spool valve body comprising a plurality of radial fluid ports, and the fluid port of the spool valve sleeve comprising a plurality of fluid ports.

10. The spool valve of claim 1, wherein:
the spool valve comprising an inverse spool valve.

11. A spool valve for a height adjustment seat post including a lower housing, a stanchion telescopically supported within the lower housing, and a cartridge including a piston rod driven by a piston to telescopically adjust the stanchion relative to the lower housing, the spool valve comprising:
a spool valve needle including a radial fluid port; and
a spool valve sleeve including a fluid port;
the spool valve sleeve slidable relative to the spool valve needle to communicate the fluid port of the spool valve sleeve with the radial fluid port of the spool valve needle to allow communication of fluid through the fluid port of the spool valve sleeve and through the radial fluid port of the spool valve needle, the fluid to act on the piston of the cartridge.

12. The spool valve of claim 11, the spool valve further comprising:
a spool valve housing,
the spool valve needle including a spool valve body positioned within the spool valve housing.

13. The spool valve of claim 12, wherein:
the spool valve sleeve slidable relative to the spool valve housing and the spool valve body of the spool valve needle.

14. The spool valve of claim 12, wherein:
the spool valve housing including a fluid port,
the spool valve sleeve slidable relative to the spool valve housing and the spool valve body of the spool valve needle to communicate the fluid port of the spool valve sleeve with the radial fluid port of the spool valve needle to allow communication of fluid through the fluid port of the spool valve housing, through the fluid port of the spool valve sleeve, and through the radial fluid port of the spool valve needle.

15. The spool valve of claim 11, wherein:
the spool valve sleeve biased to establish a closed position of the spool valve and actuated to establish an open position of the spool valve.

16. The spool valve of claim 11, wherein:
the spool valve comprising an inverse spool valve.

17. The spool valve of claim 11, wherein:
the spool valve needle including an axial fluid port communicated with the radial fluid port,
the spool valve sleeve slidable relative to the spool valve needle to communicate the fluid port of the spool valve sleeve with the radial fluid port of the spool valve needle to allow communication of fluid through the fluid port of the spool valve sleeve, through the radial fluid port of the spool valve needle, and through the axial fluid port of the spool valve needle.

18. The spool valve of claim 11, wherein:
the spool valve sleeve slidable relative to the spool valve needle to cover the radial fluid port of the spool valve needle to prevent communication of fluid through the fluid port of the spool valve sleeve and the radial fluid port of the spool valve needle.

19. The spool valve of claim 11, wherein:
in an extending state of the height adjustment seat post, fluid to flow from the fluid port of the spool valve sleeve to the radial fluid port of the spool valve needle.

20. The spool valve of claim 11, wherein:
in a compressing state of the height adjustment seat post, fluid to flow from the radial fluid port of the spool valve needle to the fluid port of the spool valve sleeve.
